(19) United States
(12) Patent Application Publication
(10) Pub. No.: US 2016/0190874 A1
(43) Pub. Date: Jun. 30, 2016

(54) SINGLE STATOR AND MOTOR COMPRISING SAME

(71) Applicant: AMOTECH CO., LTD., Incheon (KR)

(72) Inventors: Byung Soo KIM, Anyang-si (KR); Hak Rok KIM, Daegu (KR); Hyung Hwan KO, Anseong-si (KR)

(21) Appl. No.: 14/909,843

(22) PCT Filed: Aug. 25, 2014
(86) PCT No.: PCT/KR2014/007854

§ 371 Date: Feb. 3, 2016

(30) Foreign Application Priority Data
Aug. 23, 2013 (KR) 10-2013-0100551
Apr. 30, 2014 (KR) 10-2014-0052620

(51) Int. Cl. H02K 1/02; H02K 3/46; H02K 1/06

(52) U.S. Cl. CPC H02K 1/02; H02K 1/06; H02K 3/46

(57) ABSTRACT

A single stator includes: a stator core; a bobbin wrapped on an outer circumferential surface of the stator core; and a coil wound on an outer circumferential surface of the bobbin. The stator core comprises: a plurality of integration type core portions that are integrally formed by metal powders, and on which a coil is wound; and a lamination type core portion that is formed in an annular shape by laminating a plurality of iron pieces, and that has at least one press-fit groove is formed in which each of the plurality of integration type core portions is press-fitted into and combined with the at least one press-fit groove.

### TECHNICAL FIELD

The present invention relates to a motor, and more specifically, to a single stator having a configuration of a hybrid type stator core that is formed by combining a lamination type core and a compressed powder magnetic core in a manner to supplement disadvantages of and take advantages of a one-piece integration type core of the lamination type core and the compressed powder magnetic core, to thus achieve a high-power, high-speed, high-efficiency, and thin structured stator, and a motor having the same.

### BACKGROUND ART

A lot of equipment used in various fields such as high-speed machine tools, air motors and actuators, compressors of the recent techniques require electric motors enabling high-speed operations exceeding 15,000˜20,000 rpm, and in some cases up to 100,000 rpm.

Most of high-speed electric devices are manufactured with low pole count, which is to prevent magnetic materials in the electric devices to operate at higher frequencies from leading to too excessive core losses. The main cause is in the fact that soft magnetic materials used in most of motors are made up of Si—Fe alloys. In the conventional Si—Fe-based materials, the losses resulting from a magnetic field changing at a frequency of about 400 Hz or more may heat a material until the materials may often not be cooled even by any suitable cooling means.

Typically, electric motors include magnetic members formed of a plurality of stacked lamination plates made of non-oriented electric steel sheets. Each lamination plate is typically formed by stamping, punching or cutting mechanically soft non-oriented electric steel sheets into a desired shape. The formed lamination plates are stacked over one another, to thus form a rotor or stator in a desired form.

When compared to the non-oriented electric steel sheets, amorphous metals provide excellent magnetic performance, but have been considered as being unsuitable for a long time for use in bulk magnetic members for a stator and a rotor for an electric motor because of faults occurring on particular physical properties and processing.

For example, the amorphous metals are thinner and harder than the non-oriented electric steel sheets, so fabrication tools and dies are worn more rapidly. An increase in the tooling and manufacturing costs may cause fabrication of bulk amorphous metal magnetic members to fail to have commercial competitiveness as compared to conventional techniques such as punching or stamping. The thickness of the amorphous metal may also come to an increase in the lamination number of the assembled members, and also increase the total cost of an amorphous metal rotor or stator magnet assembly.

The amorphous metals are fed into thin continuous ribbons having a uniform ribbon width. However, amorphous metals are very hard materials, and thus it is very difficult to easily mold or cut the amorphous metals. When the amorphous metal ribbons undergo an annealing process to ensure peak magnetic properties, the amorphous metal ribbons take on significantly great brittleness. This makes it difficult and costly to use conventional methods to form bulk amorphous magnetic members. In addition, the brittle amorphous metal ribbons lead to concerns about the durability of the bulk magnetic members in the application of electric motors.

Taking these points into consideration, Korean Patent Application Publication No. 2002-0063604 disclosed a low-loss amorphous metal magnetic component having a polyhedral shape and including multiple layer amorphous strips, for use in a high-efficiency electric motor. The amorphous metal magnetic component may be operated in a frequency range of about 50 Hz-20,000 Hz, has a core loss so as to exhibit improved performance characteristics compared with a silicon-steel magnetic component operating in the same frequency range as that of the amorphous metal magnetic component, and has a laminated structure with an epoxy after forming a plurality of cut strips having a predetermined length by cutting an amorphous metal strip in order to form a polyhedral shaped body.

However, the above-described Korean Patent Application Publication No. 2002-0063604 disclosed that the amorphous metal ribbons having still significant brittleness are prepared through a molding process such as a cut to thus cause a problem that it is difficult to make a practical application, and did not disclose a high-speed frequency application operating in a frequency range of 50 Hz-20,000 Hz.

Meanwhile, when implementing a high-speed motor of 50,000 rpm with a high-power of 100 kW such as a drive motor for an electric vehicle, by using silicon steel sheets, eddy current is increased due to high speed rotation to thereby cause a heat generation problem. In addition, since such a motor is fabricated in a large size, it is not applicable for a drive system of an in-wheel motor structure and it is not preferable in terms of increasing weight of the vehicle.

Typically, the amorphous strip has a low eddy current loss, but it is difficult to put a conventional core for a motor that is manufactured by winding or molding and laminating the amorphous strip to a practical use because of the difficulty of a manufacturing process as pointed out in the conventional art.

As described above, the prior art amorphous strip provides superior magnetic performance as compared to the non-oriented electrical steel sheet, but has not been used as the bulk magnetic member for a stator and a rotor for an electric motor because of defects occurring in the manufacturing process.

In view of this point, Korean Patent Application Publication No. 2013-0060239 disclosed a method of manufacturing a stator in which a plurality of split type stator cores are prepared by compression-molding amorphous metal powders and assembling the plurality of split type stator cores by using a bobbin. However, the degree of adhesion between the split type stator cores falls and thus there is a problem that the magnetic resistance is increased.

In addition, in the case of compression-molding amorphous metal powders to thereby prepare split type stator cores, the structure of a mold is complicated. Further, when the split type stator cores are coupled with each other, a coupling protrusion portion that forms a coupling structure may fall off due to a weak coupling strength.

Further, the conventional method of manufacturing stator cores by using amorphous cores has not proposed a design scheme of a magnetic core that is optimal to an electric motor field having high-power, high-speed, high-torque, and high-frequency characteristics.

Furthermore, a need for improved amorphous metal motor members indicating a combination of good magnetic and physical properties needed for high-speed, high-efficiency electric appliances has emerged. Development of a manufacturing method that can be performed for use of amorphous metals efficiently and for the mass production of various types of motors and magnetic components used therefor is required.

It is difficult to wind a coil around a slotted stator. In addition, the slotted stator requires a lot of time in the coil winding and requires complicated expensive coil winding equipment. In addition, a stator core having a plurality of teeth may have an advantage capable of using a low-cost general-purpose winding machine in the coil windings by assembling split type stator cores to prepare the stator core.

A drive motor for a drum type washing machine has required a slim-type drive motor because of a narrow installation space at the rear side of a tub. To meet the slimming requirement, it is necessary to reduce a core stack height in the axial direction to form a stator core and the height of the coil winding.

In addition, the larger core stack height is increased, and the coil winding length is increased to thereby increase a copper loss and also consumption of the coil wound thereto.

Further, when employing low-cost ferrite magnets for a rotor, instead of expensive Nd magnets, an overhang design that increases sizes of the magnets is applied for an increase of the motor efficiency. Accordingly, there is a problem that an end turn loss has occurred.

As described above, in the case of configuring a stator core with only a conventional one-piece integration type core of a lamination type core and a compressed powder magnetic core, it is difficult to provide a stator of a high-speed, high-efficiency, thin and multi-slot structure.

### DISCLOSURE OF THE INVENTION

### Technical Problem

To solve the above problems or defects, it is an object of the present invention to provide a single stator having a configuration of a hybrid type stator core that is formed by combining a lamination type core and a compressed powder magnetic core in a manner to supplement disadvantages of and take advantages of a one-piece integration type core of the lamination type core and the compressed powder magnetic core, to thus achieve a high-power, high-speed, high-efficiency, and thin structured stator, and a motor having the same.

It is another object of the present invention to provide a single stator and a motor having the same, in which a stator core of a compressed powder magnetic core is prepared in a one-piece by compression-molding amorphous metal powders, soft magnetic powders or alloy powders formed by mixing the amorphous metal powders and the soft magnetic powders, to thus reduce a core loss to thereby reduce a manufacturing cost of a mold and simplify a manufacturing process.

It is still another object of the present invention to provide a single stator and a motor having the same, in which a stack height of a lamination type core portion is set to be the same as a height of a yoke portion of an integration type core portion, to thus reduce the stack height of the lamination type core portion and accordingly enable axial slimming of a motor.

It is yet another object of the present invention to provide a single stator and a motor having the same, in which a magnet of a rotor can be designed to have the same height as that of a stator core, to thus improve motor efficiency.

It is still yet another object of the present invention to provide a single stator and a motor having the same, in which a coil winding portion around which a coil is wound is formed as an integration type core portion, and a connection portion connecting between stator cores of a complex shape is formed as a lamination type core portion, in which the integration type core portion is mutually coupled with the lamination type core portion.

It is a further object of the present invention to provide a single stator and a motor having the same, in which a portion facing a rotor is formed of metal powders in an integration type, to thus form an integration type core portion, and a ring portion connecting between a yoke portion around which a coil is wound and stator cores of a complex shape is formed of a lamination type core portion, to thus prepare the single stator by mutually combining the integration type core portion and the lamination type core portion, to thereby increase efficiency by increasing a magnetization strength.

It is a still further object of the present invention to provide a single stator and a motor having the same, in which a lamination type core portion is formed in an arc shape or a circular ring shape having a predetermined angle, to thus reduce a number of times of assembling stator cores or eliminate the need to assemble the stator cores to thereby shorten an assembly process and improve productivity.

The objects of the present invention are not limited to the above-described objects, and other objects and advantages of the present invention can be appreciated by the following description and will be understood more clearly by embodiments of the present invention.

### Technical Solution

To accomplish the above and other objects of the present invention, according to an aspect of the present invention, there is provided a single stator comprising: a stator core; a bobbin wrapped on an outer circumferential surface of the stator core; and a coil wound on an outer circumferential surface of the bobbin, wherein the stator core comprises: a plurality of integration type core portions that are integrally formed by metal powders, and on which a coil is wound; and a lamination type core portion that is formed in an annular shape by laminating a plurality of iron pieces, and that has at least one press-fit groove is formed in which each of the plurality of integration type core portions is press-fitted into and combined with the at least one press-fit groove, and wherein the bobbin surrounds some of the outer circumferential surfaces of the plurality of integration type core portions and the lamination type core portion so as to integrate the plurality of integration type core portions and the lamination type core portion.

Preferably but not necessarily, the integration type core portion comprises: a yoke portion on which a coil is wound; and a flange portion that is integrally formed at one end of the yoke portion and that is disposed to face to a rotor, and wherein coil winding grooves whose heights are lower than those of the upper and lower surfaces of the flange portion are formed on the upper and lower surfaces of the yoke portion, so as to reduce the height of the stator core.

Preferably but not necessarily, the coil winding grooves include a first coil winding groove that is formed on the upper surface of the yoke portion and that is formed in a concave shape inwardly by a height H2 as compared to the upper surface of the flange portion, and a second coil winding groove that is formed on the lower surface of the yoke portion and that is formed in a concave shape inwardly by a height H3 as compared to the lower surface of the flange portion.

Preferably but not necessarily, the integration type core portion is formed of amorphous metal powders, soft magnetic powders or alloy powders that are formed by mixing amorphous metal powders and spherical type soft magnetic powders.

Preferably but not necessarily, the lamination type core portion comprises: a connecting portion on which a press-fit groove is formed in which the other end of the yoke portion is press-fitted into the press-fit groove; a coupling protrusion that is spherically formed on one side of the connecting portion; and a locking groove that is spherically formed so that a coupling protrusion of a lamination type core portion adjacent to the other side of the connecting portion is fitted into and coupled with the locking groove.

Preferably but not necessarily, a stack height of the lamination type core portion is set to be the same as a height of the yoke portion.

Preferably but not necessarily, a plurality of the press-fit grooves are formed at a predetermined interval on an outer surface of the lamination type core portion in which the respective integration type core portions are press-fitted into the press-fit grooves, a locking groove is formed at one end of the lamination type core portion, and a coupling protrusion is formed at the other end of the lamination type core portion so that the coupling protrusion is inserted into the locking groove formed in a neighboring lamination type core portion, and wherein the lamination type core portion is formed annularly in an arc form of a predetermined angle when the lamination type core portion is assembled with the neighboring lamination type core portion.

Preferably but not necessarily, the bobbin is formed by an insert-molding method on each of the outer circumferential surfaces of the annularly arranged lamination type core portion and the integration type core portions.

Preferably but not necessarily, the lamination type core portion is formed into a circular ring shape, in which a plurality of the press-fit grooves are formed at a predetermined interval on an outer surface of the lamination type core portion.

According to another aspect of the present invention, there is provided a single stator comprising: a stator core; a bobbin wrapped on an outer circumferential surface of the stator core; and a coil wound on an outer circumferential surface of the bobbin, wherein the stator core comprises: a lamination type core portion that is formed by laminating a plurality of iron pieces, and that comprises: a ring portion that is formed in an annular shape; a yoke portion that is extended from one side of the ring portion and on which the coil is wound; and a plurality of integration type core portions into which the yoke portion is press-fitted and that is integrally formed by compression-molding metal powders.

Preferably but not necessarily, the ring portion is formed in any one type of a type forming an annular shape in the case of being split and mutually assembled, a type forming an annular shape in the case of being formed of an arc shape and mutually assembled, and a third type forming a ring shape.

Preferably but not necessarily, the bobbin is formed to surround some of the outer circumferential surfaces of the integration type core portions and the lamination type core portion, so as to integrate the integration type core portions and the lamination type core portion.

Preferably but not necessarily, the ring portion and the yoke portion of the lamination type core portion are formed in an identical height.

According to another aspect of the present invention, there is provided a motor comprising: a single stator comprising: a stator core; a bobbin wrapped on an outer circumferential surface of the stator core; and a coil wound on an outer circumferential surface of the bobbin; and a single rotor that is disposed at a predetermined gap on an outer or inner circumferential surface of the single stator, wherein the stator core comprises: a plurality of integration type core portions that are integrally formed by metal powders, and on which a coil is wound; and a lamination type core portion that is formed in an annular shape by laminating a plurality of iron pieces, and that has at least one press-fit groove is formed in which each of the plurality of integration type core portions is press-fitted into and combined with the at least one press-fit groove, and wherein the bobbin surrounds some of the outer circumferential surfaces of the plurality of integration type core portions and the lamination type core portion so as to integrate the plurality of integration type core portions and the lamination type core portion.

According to another aspect of the present invention, there is provided a motor comprising: a single stator comprising: a stator core; a bobbin wrapped on an outer circumferential surface of the stator core; and a coil wound on an outer circumferential surface of the bobbin; and a single rotor that is disposed at a predetermined gap on an outer or inner circumferential surface of the single stator, wherein the stator core comprises: a lamination type core portion that is formed by laminating a plurality of iron pieces, and that comprises: a ring portion that is formed in an annular shape; a yoke portion that is extended from one side of the ring portion and on which the coil is wound; and a plurality of integration type core portions into which the yoke portion is press-fitted and that is integrally formed by compression-molding metal powders.

Preferably but not necessarily, the rotor comprises: a magnet that is arranged with a certain gap from a flange portion; a back yoke that is disposed on the rear surface of the magnet; and a rotor support to which the magnet and the back yoke are fixed, and that is coupled to a rotating shaft, and wherein a height of the magnet is formed in the same height as that of the flange portion.

### Advantageous Effects

As described above, the present invention provides a single stator and a motor having the same, in which a stator core of a compressed powder magnetic core is prepared in a one-piece by compression-molding amorphous metal powders, soft magnetic powders or alloy powders formed by mixing the amorphous metal powders and the soft magnetic powders, to thus reduce a core loss to thereby reduce a manufacturing cost of a mold and simplify a manufacturing process.

In addition, the present invention provides a single stator and a motor having the same, in which a stack height of a lamination type core portion is set to be the same as a height of a yoke portion of an integration type core portion, to thus reduce the stack height of the lamination type core portion and accordingly enable axial slimming of a motor so as to be usefully applied for a drum type washing machine.

In addition, according to the present invention, the circumferential length of a core is reduced by making an area of a core (a yoke portion) around which a coil is wound equal and reducing the height thereof, to thereby reduce a copper loss and a weight of the coil.

In addition, a motor having an integration type stator core portion according to the present invention is provided in which a magnet of a rotor can be designed to have the same height as that of a stator core, to thus improve motor efficiency.

In addition, a single stator and a motor having the same according to the present invention are provided in which a coil winding portion around which a coil is wound is formed as an integration type core portion, and a connection portion connecting between stator cores of a complex shape is formed as a lamination type core portion, in which the integration type core portion is mutually coupled with the lamination type core portion, to thereby prepare a stator core whose shape is complicated in a one-piece form.

In addition, a single stator and a motor having the same according to the present invention are provided in which a yoke portion around which a coil is wound is formed as a lamination type core portion when an integration type core portion is mutually combined with the lamination type core portion to thereby increase efficiency by increasing a magnetization strength as compared with a case of forming the yoke portion with amorphous metal powders.

In addition, a single stator and a motor having the same according to the present invention are provided in which a lamination type core portion is formed in an arc shape or a circular ring shape having a predetermined angle, to thus reduce a number of times of assembling stator cores or eliminate the need to assemble the stator cores to thereby shorten an assembly process and improve productivity.

### DESCRIPTION OF DRAWINGS

FIG. 1 is a cross-sectional view of a motor according to a first embodiment of the present invention.

FIG. 2 is a partial plan view of the motor according to the first embodiment of the present invention.

FIG. 3 is a cross-sectional view showing an arrangement of a stator and a rotor of the motor according to the first embodiment of the present invention.

FIG. 4 is a perspective view showing a complete split-type stator core according to the first embodiment of the present invention.

FIG. 5A is a plan view of a stator core according to the first embodiment of the present invention.

FIG. 5B is a plan view of a stator core in which a bobbin is formed according to the first embodiment of the present invention.

FIG. 6 is an exploded plan view showing a modification of a stator core according to the first embodiment of the present invention.

FIG. 7 is a flowchart view illustrating a manufacturing process of a single stator according to the first embodiment of the present invention.

FIG. 8 is a flowchart view illustrating another manufacturing process of a single stator according to the first embodiment of the present invention.

FIG. 9 is a plan view of an entire single stator in which a bobbin is formed according to the first embodiment of the present invention.

FIG. 10 is a plan view of annularly arranged stator cores according to a second embodiment of the present invention.

FIG. 11 is a partially enlarged plan view of a first lamination type core portion of the stator cores according to the second embodiment of the present invention.

FIG. 12 is a plan view of stator cores in which bobbins are respectively formed according to the second embodiment of the present invention.

FIG. 13 is a plan view of stator cores according to a third embodiment of the present invention.

FIG. 14 is a partially enlarged plan view of a lamination type core portion of the stator cores according to the third embodiment of the present invention.

FIG. 15 is a plan view of a stator core according to a fourth embodiment of the present invention.

FIG. 16 is a plan view of a stator core in which a bobbin is formed according to the fourth embodiment of the present invention.

FIG. 17 is a cross-sectional view showing a stator according to the fourth embodiment of the present invention.

### BEST MODE

Hereinafter, embodiments of the present invention will be described in detail with reference to the accompanying drawings. In the process, the size and shape of the components illustrated in the drawings may be exaggerated for convenience and clarity of explanation. Further, by considering the configuration and operation of the present invention, the specifically defined terms can be changed according to user's or operator's intention, or the custom. Definitions of these terms herein need to be made based on the contents across the whole application.

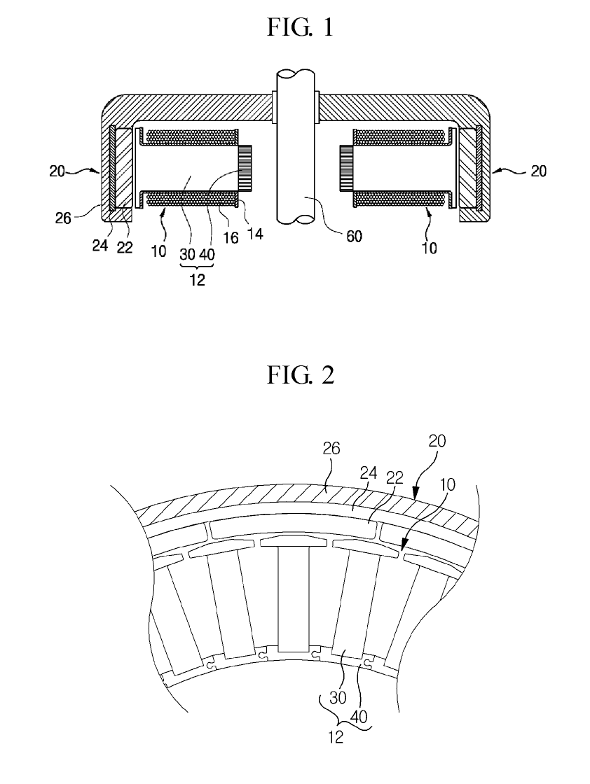

Referring to FIGS. 1 and 2, a motor according to a first embodiment of the present invention includes: a single stator 10; and a rotor 20 that is disposed at a predetermined gap on an outer circumferential surface of the stator 10 in which the rotor 20 is connected to a rotating shaft 60.

The rotor 20 includes: a magnet 22 that is disposed at a predetermined gap from the outer surface of the stator 10; a back yoke 24 that is disposed on a back surface of the magnet 22; and a rotor support 26 to which the magnet 22 and the back yoke 24 are fixed and which is connected to the rotating shaft 60.

The single stator 10 includes: a plurality of stator cores 12 that are disposed in an annular form; a plurality of insulation-material bobbins 14 wrapped on the respective outer circumferential surfaces of the plurality of stator cores 12; a coil 16 wound on an outer surface of each of the bobbins 14.

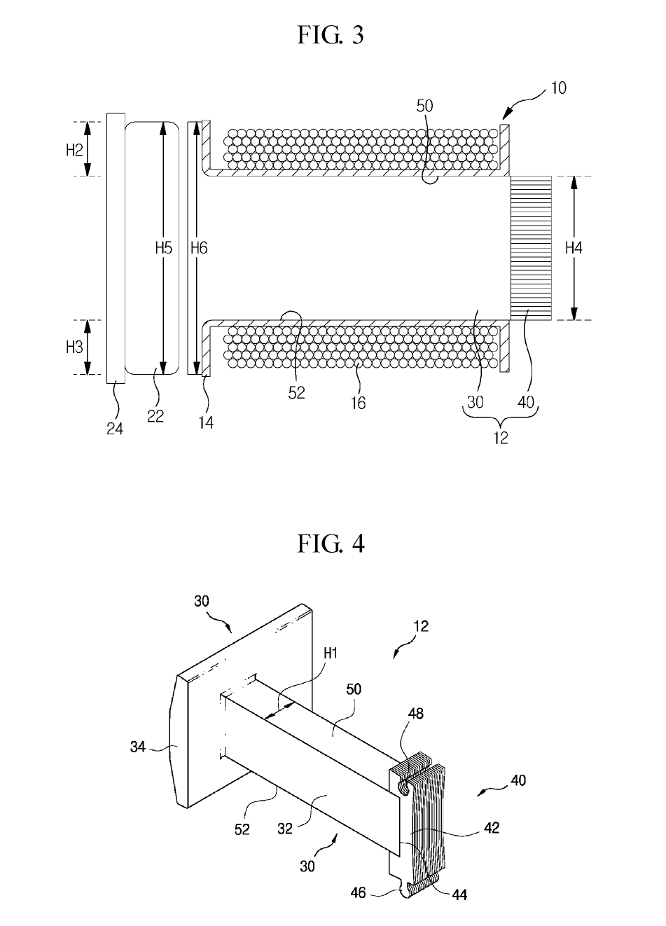

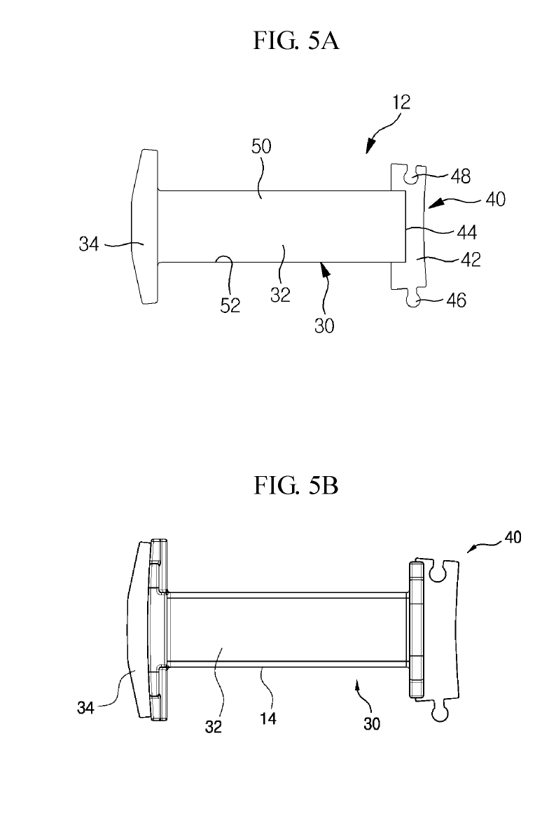

As shown in FIGS. 3 to 5B, the stator core 12 includes: an integration type core portion (that is, a compressed powder magnetic core portion) 30 that is integrally formed by compression-molding amorphous metal powders in a mold; and a lamination type core portion 40 that is formed by laminating a plurality of iron pieces and that is combined with the integration type core portion 30.

The integration type core portion 30 includes: a yoke portion 32 on which the coil 16 is wound; and a flange portion 34 that is integrally formed at one end of the yoke portion 32 and that is disposed to face the rotor 20.

The integration type core portion 30 is formed by mixing amorphous metal powders with a binder at a predetermined ratio and molding the mixture, or by mixing amorphous metal powders and crystalline metal powders having excellent soft magnetic properties with a binder at a predetermined ratio and molding the mixture. In this case, mixing the metal powders at the predetermined ratio may eliminate difficulty of a high-pressure sintering and increase the permeability as compared to using the amorphous metal powders at 100%.

The integration type core portion 30 may be also prepared by compression-molding only the soft magnetic powders. The integration type core portion 30 may be also extruded in addition to compression-molding.

The coil 16 is wound on outer circumferential surface of the yoke portion 32. Here, coil winding grooves 50 and 52 are formed at the upper and lower surfaces of the yoke portion 32, respectively. That is, a height H1 of the yoke portion 32 is made small, and the upper and lower surfaces of the yoke portion 32 are recessed to form a concave shape to have lower heights as compared to the flange portion 34, to thus form the coil winding grooves 50 and 52.

The coil winding grooves 50 and 52 include a first coil winding groove 50 that is formed on the upper surface of the yoke portion 32, and that is formed in a concave shape inwardly by a height H2 as compared to the upper surface of the flange portion 34, and a second coil winding groove 52 that is formed on the lower surface of the yoke portion 32, and that is formed in a concave shape inwardly by a height H3 as compared to the lower surface of the flange portion 34.

In this case, a stack height H2 of the lamination type core portion 50 is set to be the same as heights H5 and H1 of the first and second yoke portions 32 and 42.

In this way, the axial height of the stator core 10 is reduced to thus reduce the overall height of the motor, enable slimming of the motor, and reduce the circumferential areas of the yoke portion 32, to thereby reduce coil winding quantities and reduce a copper loss in the case of exhibiting identical performance.

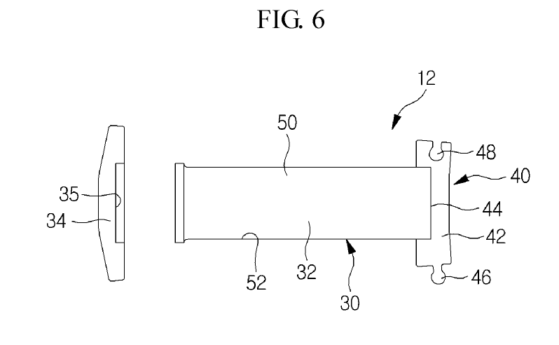

Here, as shown in FIG. 6, the integration type core portion 30 may be formed by separately molding the yoke portion 32 and the flange portion 34 via a compression molding or extrusion molding process, and then mutually assembling the yoke portion 32 and the flange portion 34 in a later step.

That is, a press-fit groove 35 is formed on the flange portion 34, and thus one end of the yoke portion 32 is press-fitted into the press-fit groove 35. Besides, the flange portion 34 and the yoke portion 32 may be mutually assembled via a bonding process.

The lamination type core portion 40 includes: a connecting portion 42 on which a press-fit groove 44 is formed in which the other end of the yoke portion 32 is press-fitted into the press-fit groove 44; a coupling protrusion 46 that is spherically formed on one side of the connecting portion 42; and a locking groove 48 that is spherically formed so that a coupling protrusion 46 of a lamination type core portion 40 adjacent to the other side of the connecting portion 42 is fitted into and coupled with the locking groove 48.

The yoke portion 32 of the integration type core portion 30 is press-fitted and assembled with the press-fit groove 44 of the lamination type core portion 40. However, the integration type core portion 30 and the lamination type core portion 40 may be bonded for reinforcing the strength of the assembly therebetween.

The lamination type core portion 40 may directly connect between the stator cores 12 that are arranged radially to thus be mutually energized between the split type stator cores 12 to thereby form a magnetic circuit while forming a back yoke.

In addition to this connection structure, although not shown in the drawings, the lamination type core portion 40 may employ a structure of connecting between the stator cores in which pinholes are formed at both end portions of the connecting portion 52 of each of the stator cores, and a pin member is fitted into and coupled with the pinholes of two stator cores at a state where the stator cores contact each other. In addition, although not shown in the drawings, the lamination type core portion 40 may employ a method of caulking the stator cores by using a caulking member in a state where the stator cores contact each other.

Since the lamination type core portion 40 is formed by laminating a plurality of iron pieces, so the strength of the iron pieces is strong, the coupling protrusion 46 is separated from the connecting portion 42.

However, in the case that the lamination type core portion 40 is prepared by compression-molding amorphous metal powders as in the integration type core portion 30, there are concerns that the coupling protrusion 57 may fall off due to a complex mold structure and a weak strength.

Therefore, in the first embodiment, a portion of connecting between the plurality of complete split-type stator cores is prepared by laminating a plurality of iron pieces having a strong strength, and a coil winding portion is prepared by compression-molding amorphous metal powders, thereby reducing costs and improving motor performance.

A stack height (H4) of the lamination type core portion 40 is formed identically to the height (H1) of the yoke portion 32 of the integration type core portion 30, to thus reduce the stack height (H4) of the lamination type core portion 40 to accordingly reduce a manufacturing cost.

As shown in FIG. 3, in the motor according to the first embodiment, the height (H5) of the magnet 22 may be designed identically to the height (H6) of the flange portion 34, to thus reduce the height of the motor and increase the motor efficiency.

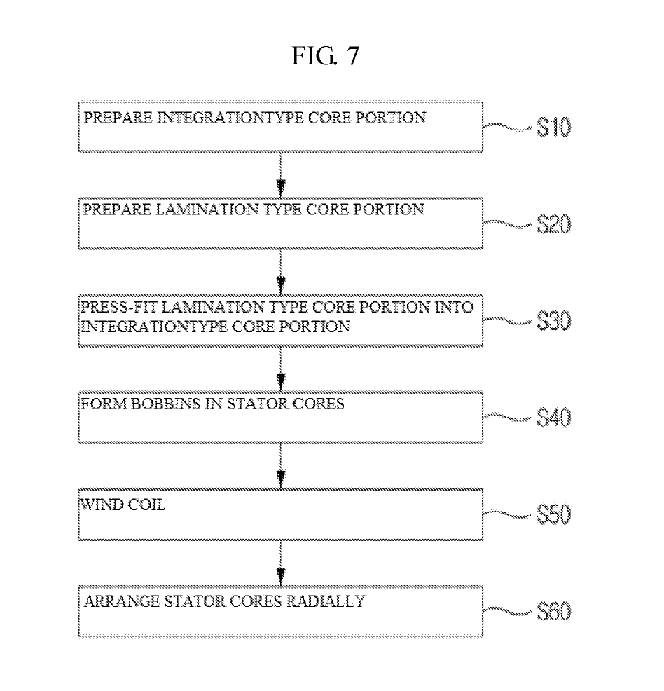

It will be described with respect to a method of manufacturing a stator according to an embodiment of the present invention in the following. FIG. 7 is a flowchart view illustrating a method of manufacturing a stator according to an embodiment of the present invention.

First, an integration type core portion 30 is formed by compression-molding amorphous metal powders (S10).

The integration type core portion 30 may be formed by mixing amorphous metal powders with a binder at a predetermined ratio and molding the mixture, or by mixing amorphous metal powders and crystalline metal powders having excellent soft magnetic properties with a binder at a predetermined ratio and molding the mixture. In addition, the integration type core portion 30 may be formed by mixing crystalline metal powders having excellent soft magnetic properties with a binder at a predetermined ratio and molding the mixture.

Then, a lamination type core portion 40 is prepared separately from the integration type core portion 30 (S20).

That is, a press-fit groove 44, a coupling protrusion 47, and a locking groove 58 are integrally formed in one piece by cutting iron steel sheets. Then, a plurality of steel plates are laminated. Here, the stack height of the lamination type core portion 40 is formed identically to the height of the yoke portion 32 of the integration type core portion 30.

In addition, the integration type core portion 30 is press-fitted into the press-fit groove 44 formed on the lamination type core portion 40 (S30). That is, the end of the yoke portion 32 of the integration type core portion 30 is fixed to the press-fit groove 44 in a forced press-fitting manner.

A bobbin 14 is formed by insert molding a resin of an insulating material on the outer surfaces of the integration type core portion 30 and the lamination type core portion 40 (S40). Here, the outer surface of the flange portion 34 of the integration type core portion 30, and the coupling protrusion 46 and the locking groove 48 of the lamination type core portion 40 are exposed to the outside without being wrapped by the resin of the insulating material.

The coil 16 is sequentially wound on the outer surface of the bobbin 14 (S50). In addition, when the coupling protrusions 46 of the stator cores are respectively fitted into the locking grooves 48 of the neighboring stator cores and the plurality of stator cores 12 are radially arranged, an assembly of the stator 10 is completed (S60).

The above-described method of preparing the stator has been described with respect to the case of forming a separate bobbin 14 for each stator core 12 and assembling the separately formed bobbins 12 with the stator cores, but the present invention is not limited thereto.

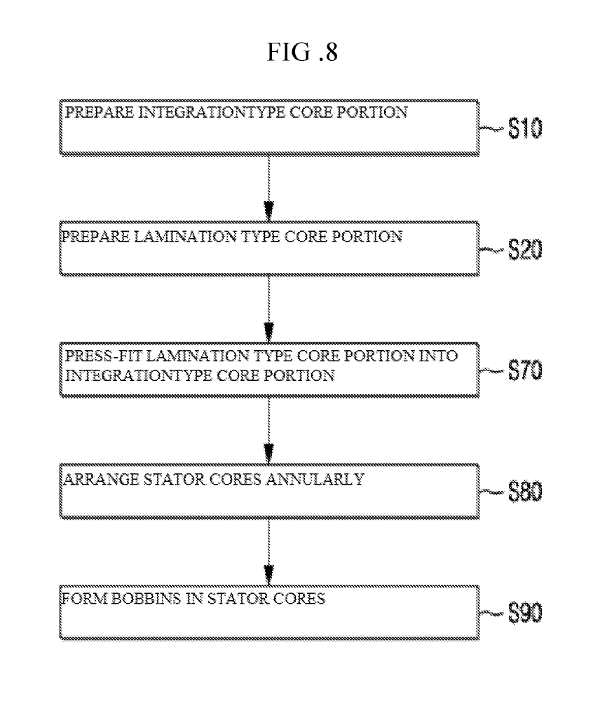

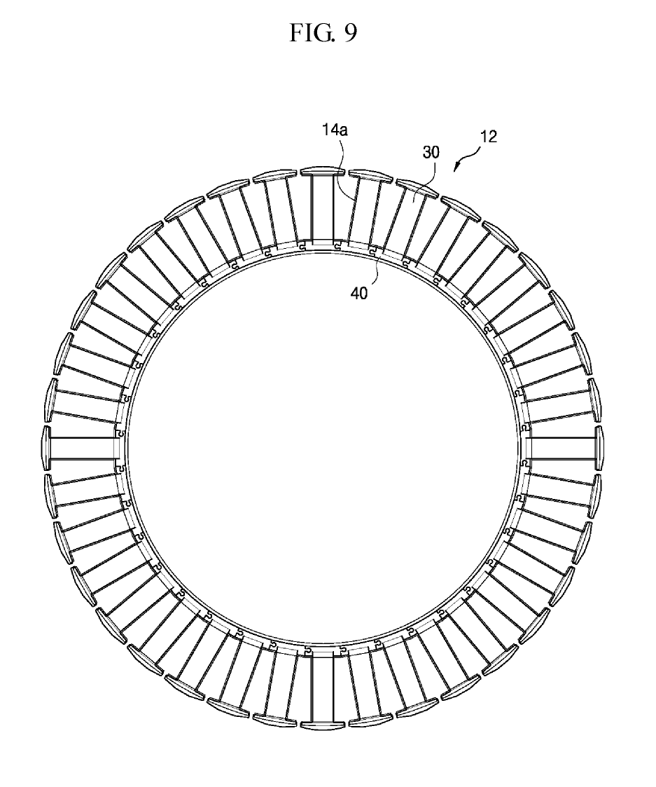

FIG. 8 is a flowchart view illustrating another manufacturing process of a single stator according to the first embodiment of the present invention. FIG. 9 is a plan view of an entire single stator in which a bobbin is formed according to the first embodiment of the present invention.

A method of manufacturing a single stator according to another embodiment of the present invention has the same process as that shown in FIG. 7 in the process of producing an integration type core portion and a lamination type core portion from step S10 to step S20 shown in FIG. 8.

Then, an integration type core portion 30 is press-fitted into a press-fit groove 44 formed in a lamination type core portion 40 (S70). That is, the end of the yoke portion 32 of the integration type core portion 30 is fixed to the press-fit groove 44 in a forced press-fitting method.

In addition, as shown in FIG. 9, stator cores are arranged in an annular form (S80). That is, a coupling protrusion 46 of a stator core is inserted into a locking groove 48 of a neighboring stator core to thus arrange the stator cores 12 in the form of a ring. In addition, a bobbin 14a is formed by insert molding a resin of an insulating material on the outer surfaces of the integration type core portion 30 and the lamination type core portion 40 (S90).

In this case, the bobbin 14a is integrally formed, and flange portions are formed on both sides of the bobbin 14a, while surrounding the yoke portion 32 of the integration type core portion 30 and a portion of the lamination type core portion 40, to thereby define a region around which the coil 16 is wound and simultaneously enhance a coupling strength between the integration type core portion 30 and a portion of the lamination type core portion 40.

The bobbin 14a may be formed by assembling an upper cover and a lower cover, as needed.

Then, the coil 16 is wound on each of the bobbins 14a.

Hereinbelow, a method of manufacturing the integration type core portion 30 according to an embodiment of the present invention will be described. As an example, a method of manufacturing the integration type core portion 30 will be described with respect to a case of using amorphous metal powders.

In the case of the integration type core portion 30 according to the embodiment of the present invention, an amorphous alloy is manufactured into ultra-thin type amorphous alloy ribbons or strips of 30 μm or less by using a rapid solidification processing (RSP) method through a melt spinning process, and then the ultra-thin type amorphous alloy ribbons or strips are pulverized, to thus obtain amorphous metal powders. Here, the obtained amorphous metal powders have a size in the range of 1 to 150 μm.

In this case, the amorphous alloy ribbons or strips may be heat-treated at 400-600° C. under a nitrogen atmosphere, so as to have a nanocrystalline microstructure that can promote high permeability.

In addition, the amorphous alloy ribbons or strips may be heat-treated at 100-400° C. in the air, to improve the pulverization efficiency.

Of course, it is possible to use spherical powders obtained as the amorphous metal powders by an atomization method other than the pulverization method of the amorphous alloy ribbons or strips.

For example, any one of Fe-based, Co-based, and Ni-based amorphous alloys may be used as the amorphous alloy. Preferably, a Fe-based amorphous alloy is advantageous in terms of price. The Fe-based amorphous alloy is preferably any one of Fe—Si—B, Fe—Si—Al, Fe—Hf—C, Fe—Cu—Nb—Si—B, and Fe—Si—N. In addition, the Co-based amorphous alloy is preferably any one of Co—Fe—Si—B and Co—Fe—Ni—Si—B.

Thereafter, the amorphous metal powders are classified depending on the size of the particle, and then mixed in a powder particle size distribution having optimal composition uniformity. In this case, since the amorphous metal powders are made up preferably in a plate shape, a packing density is lowered below the optimal condition, when the amorphous metal powders are mixed with a binder to then be molded into a shape of components. Accordingly, the present invention uses a mixture of a predetermined amount of spherical soft magnetic powders with plate-shaped amorphous metal powders, to thus increase the molding density, in which the spherical soft magnetic powders are made of spherical powder particles, to promote improvement of magnetic properties, that is, permeability.

For example, one of MPP powders, HighFlux powders, Sendust powders, and iron powders, or a mixture thereof may be used as the spherical soft magnetic powders that may promote improvement of the permeability and the packing density.

A binder mixed in the mixed amorphous metal powders is, for example, a thermosetting resin such as sodium silicate called water glass, ceramic silicate, an epoxy resin, a phenolic resin, a silicone resin or polyimide. In this case, the maximum mixing ratio of the binder is preferably 20 wt %.

The mixed amorphous metal powders are compression-molded into a desired shape of cores or back yokes by using presses and molds at a state where binders and lubricants have been added in the amorphous metal powders. When a compression-molding process is achieved by presses, a molding pressure is preferably set to 15-20 ton/cm².

After that, the molded cores or back yokes are sintered in the range of 300-600° C. for 10-600 min to implement magnetic properties.

In the case that the heat-treatment temperature is less than 300° C., heat treatment time increases to thus cause a reduction in productivity, and in the case that heat-treatment temperature exceeds 600° C., deterioration of the magnetic properties of the amorphous alloys occurs.

In addition, in some embodiments of the present invention, only soft magnetic powders can be compression-molded other than the amorphous metal powders.

As described above, since amorphous metal powders or soft magnetic powders are compression-molded, in some embodiments of the present invention, the integration type core portions of complex shapes are easily molded, and the crystalline metal powders having excellent soft magnetic properties is also added in the amorphous metal powders, to thereby promote improvement of the magnetic permeability and improvement of the molding density at the time of compression-molding.

Furthermore, when the first integration type core portion and the second integration type core portion are manufactured, in some embodiments of the present invention, the first integration type core portion and the second integration type core portion are molded by using amorphous metal powders or soft magnetic powders, or by using a mixture of crystalline metal powders with amorphous metal powders, to thereby minimize an eddy current loss (or a core loss), and to thus be appropriate to be used as a high speed motor of over 50,000 rpm.

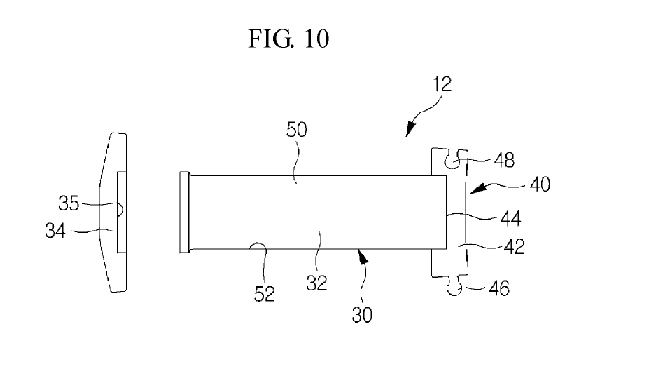

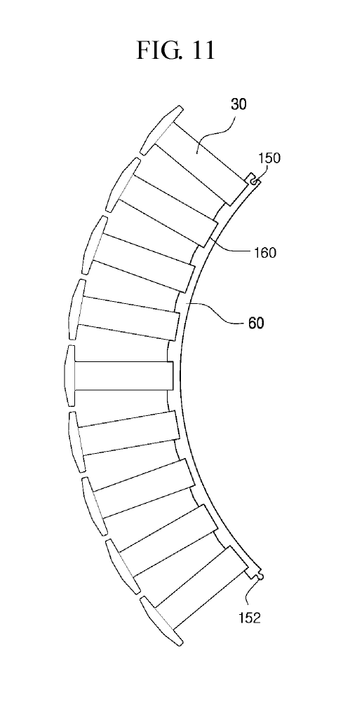

FIG. 10 is a plan view of annularly arranged stator cores according to a second embodiment of the present invention and FIG. 11 is a partially enlarged plan view of a first lamination type core portion of the stator cores according to the second embodiment of the present invention.

The stator core according to the second embodiment of the present invention includes: four lamination type core portions 60, 62, 64 and 66 that are mutually assembled to form an annular shape and that are formed by laminating a plurality of iron pieces; and a plurality of integration type core portions 30 that are integrally formed by compression-molding amorphous metal powders in a mold, and that are fixed in a radial form on the outer surface of the lamination type core portions 60, 62, 64 and 66.

Here, the integration type core portions 130 according to the second embodiment of the present invention are equal to the integration type core portion 30 according to the first embodiment of the present invention.

The lamination type core portions 60, 62, 64 and 66 include: a first lamination type core portion 60 that is formed of a circular arc shape of a predetermined angle; a second lamination type core portion 62 that is subsequently assembled to the first lamination type core portion 60, and that is formed in the same fashion as that of the first lamination type core portion 60; a third lamination type core portion 64 that is subsequently assembled to the second lamination type core portion 62, and that is formed in the same fashion as that of the second lamination type core portion 62; and a fourth lamination type core portion 66 that is assembled between the third lamination type core portion 64 and the first lamination type core portion 60, and that is formed in the same fashion as that of the third lamination type core portion 64.

The first lamination type core portion 60, the second lamination type core portion 62, the third lamination type core portion 64, and fourth lamination type core portion 66 are formed, for example, in a circular arc shape of 90° in which a locking groove 150 is formed on one end of each of the first to fourth lamination type core portions 60, 62, 64 and 66, and a coupling protrusion 152 is formed on the other end of each of the first to fourth lamination type core portions 60, 62, 64 and 66, in which the coupling protrusion 152 is fitted into the locking groove 150.

A plurality of press-fit grooves 160 are formed at a predetermined interval on outer surfaces of the first to fourth lamination type core portions 60, 62, 64 and 66, in which a plurality of the integration type core portions 30 are press-fitted into and fixed to the plurality of press-fit grooves 160, respectively.

The four lamination type core portions are illustrated in the second embodiment on the drawing, but three lamination type core portions that are formed at an interval of 120° may be available, and two lamination type core portions that are formed at an interval of 180° may be available. In addition, lamination type core portions over four may be available.

When looking at the assembly process of the single stator according to the second embodiment as described above, the integration type core portions 30 are first press-fitted into the press-fit grooves 160 of the first lamination type core portion 60, the second lamination type core portion 62, the third lamination type core portion 64 and the fourth lamination type core portion 66.

The first lamination type core portion 60, the second lamination type core portion 62, the third lamination type core portion 64 and the fourth lamination type core portion 66 are mutually assembled with each other to thus form an annular shape. In other words, the coupling protrusions 152 are inserted into the locking grooves 150, respectively, to thereby assemble the plurality of lamination type core portions 60, 62, 64, and 66 in an annular form.

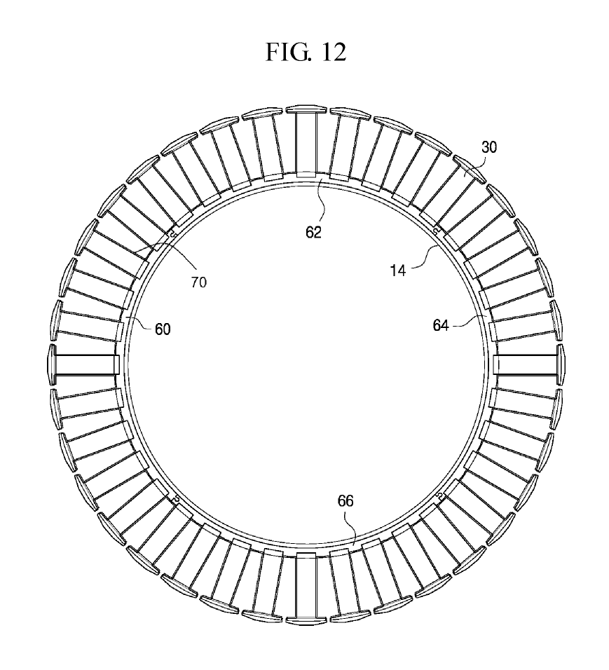

Then, as shown in FIG. 12, integration type bobbins 70 are formed by insert molding a resin of an insulating material on the outer surfaces of the annularly arranged lamination type core portions 60, 62, 64, and 66 and the integration type core portions 30, respectively. In this case, the bobbins 70 are formed by insert molding the stator cores arranged in an annular form once, to thereby simplify the manufacturing process.

As described above, since the stator cores according to the second embodiment are formed in arc shape having a predetermined angle, an assembly process of mutually assembling the lamination type core portions can be reduced to thus simplify a manufacturing process.

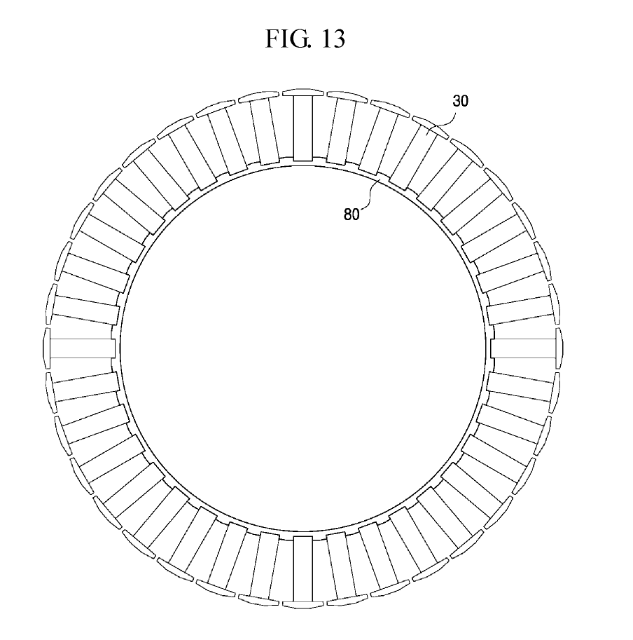

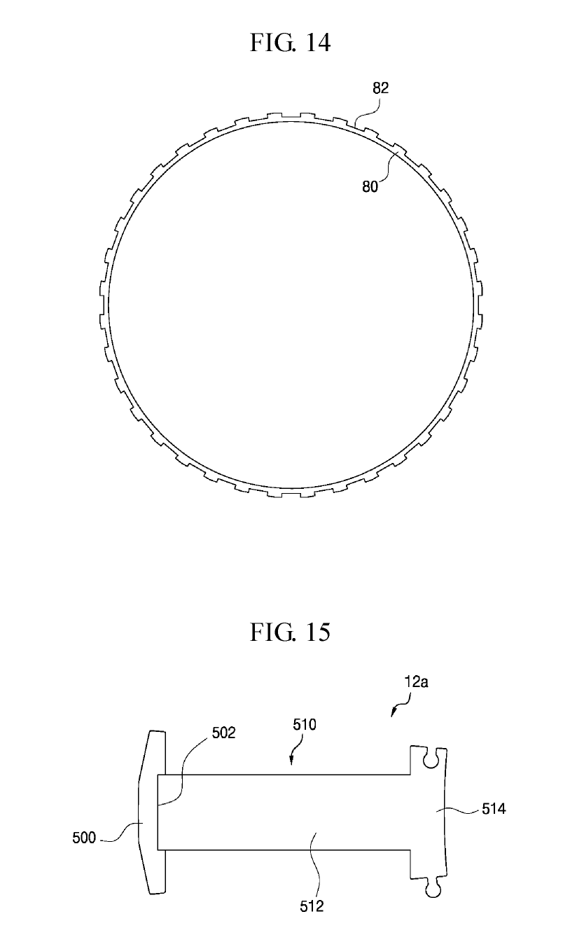

FIG. 13 is a plan view of stator cores according to a third embodiment of the present invention. FIG. 14 is a plan view of a lamination type core portion according to the third embodiment of the present invention.

Referring to FIGS. 13 and 14, the stator core according to the third embodiment of the present invention includes: a lamination type core portion 80 that is formed in an annular shape; a plurality of integration type core portions 30 that are integrally formed by compression-molding amorphous metal powders in a mold, and that are fixed in a radial form on the outer surface of the lamination type core portion 80.

Here, the lamination type core portion 80 is formed into a circular ring shape, and is formed by laminating a plurality of iron pieces, in which a plurality of press-fit grooves 80 are formed at a predetermined interval on an outer surface of the lamination type core portion 80 in which the plurality of integration type core portions 30 are press-fitted into the plurality of the press-fit grooves 82, respectively.

Thus, since the stator core according to the third embodiment is configured to include the lamination type core portion that is formed in an integral ring-shaped core shape, the stator cores do not have to be assembled to each other, to improve productivity.

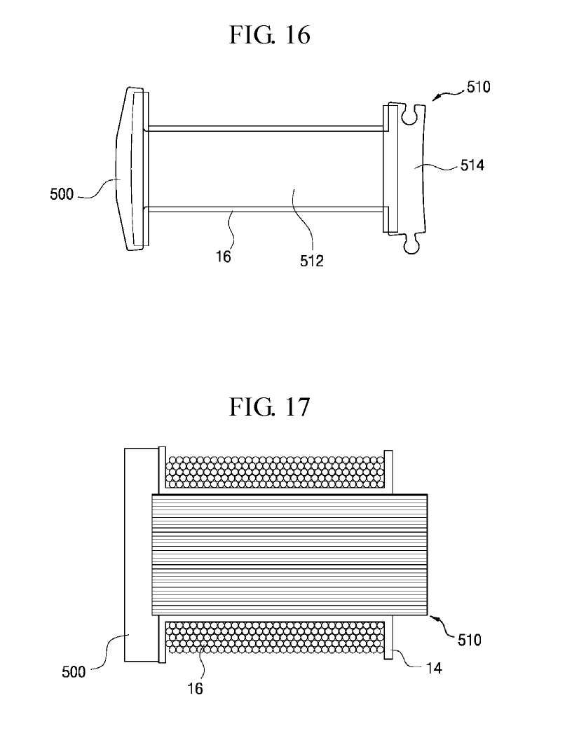

FIG. 15 is a plan view of a split-type stator core according to a fourth embodiment of the present invention. FIG. 16 is a plan view of a stator core in which a bobbin is formed according to the fourth embodiment of the present invention. FIG. 17 is a cross-sectional view showing a stator according to the fourth embodiment of the present invention.

Referring to FIGS. 15 to 17, the stator core 12a according to the fourth embodiment of the present invention includes: an integration type core portion 500 that is integrally formed by compression-molding amorphous metal powders in a mold; and a lamination type core portion 510 that is formed by laminating a plurality of iron pieces in which the integration type core portion 500 is press-fitted into and fixed to the lamination type core portion 510.

The integration type core portion 500 is formed in a flange shape so that the integration type core portion 500 is press-fitted with and fixed to one end of the lamination type core portion 510, and is prepared in the same way as that of the integration type core portion 30 according to the first embodiment of the present invention.

Then, the lamination type core portion 510 includes: a ring portion 514 formed in an annular shape when assembled with the neighboring ring portions 514; and a yoke portion 512 that extends from one side of the ring portion 522 and on which a coil 16 is wound.

The lamination type core portion 510 is prepared in the same manner as the lamination type core portion 40 described in the first embodiment above. A press-fit groove 502 is formed on the integration type core portion 500, in which the yoke portion 512 is press-fitted into and fixed to the press-fit groove 502.

The ring portion 522 is formed in any one type of a type forming an annular shape in the case of being split and mutually assembled, as in the first embodiment, a type forming an annular shape in the case of being formed of an arc shape and mutually assembled, as in the second embodiment, and a type forming a ring shape as in the third embodiment.

As described above, the stator core 12a according to the fourth embodiment of the present invention is configured to include: the yoke portion 512 around which the coil 16 is wound and the ring portion 514 that is formed so as to be mutually connected with the other ring portion 514 or so as to be formed in a ring shape, by laminating the plurality of iron pieces; and the integration type core portion 500 that is press-fitted with and fixed to the end portion of the yoke portion 512 that is integrally formed by compression-molding amorphous metal powders in a mold.

Thereafter, the lamination type core portion 510 is press-fitted with and fixed to the press-fit groove 502 of the integration type core portion 500 and then a resin of an insulating material is insert molded on the outer surfaces of the integration type core portion 500 and the lamination type core portion 510, to thereby form a bobbin 14.

In this case, the bobbin 14 is formed in an integration type. The bobbin 14 plays a role of defining a region on which the coil 16 is wound as flange portions are formed at both sides of the bobbin 14 while surrounding part of the integration type core portion 500 and the lamination type core portion 510, and strengthening a coupling strength between the integration type core portion 500 and the lamination type core portion 510.

The bobbin may have a top cover and a bottom cover which can be assembled with and formed in the bobbin, as necessary.

Then, the coil 16 is wound on each of the bobbins 14, and a number of stator coils 12a around which the coils are wound are assembled in an annular form, to thus form a stator.

According to the stator cores 12a according to the fourth embodiment, when the yoke portion 512 around which the coil 16 is wound is formed of the lamination type core portion, a magnetization strength becomes high to thereby increase efficiency as compared with a case that the yoke portion is formed of amorphous metal powders.

In addition, the stator core 12a according to the fourth embodiment is also configured so that the stack height of the lamination type core portion 510 is formed identically to the height of the yoke portion 512, in the same manner as that of the first embodiment, to thereby reduce the stack height of the lamination type core portion 510.

Accordingly, it is possible to achieve axial slimming of the entire motor by reducing the height of the yoke portion around which the coil is wound, and the circumferential length of a core is reduced by making an area of the core (the yoke portion) equal and reducing the height thereof, to thereby reduce a copper loss and a weight of the coil. Further, a motor employing the stator according to the fourth embodiment of the present invention may be also designed to have height of a magnet 22 identical to that of the integration type core portion 500, to thus enhance motor efficiency while lowering height of the motor.

As described above, the present invention has been described with respect to particularly preferred embodiments. However, the present invention is not limited to the above embodiments, and it is possible for one of ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

The present invention can be applied to a single stator having a configuration of a hybrid type stator core that is formed by combining a lamination type core and a compressed powder magnetic core in a manner to supplement disadvantages of and take advantages of a one-piece integration type core of the lamination type core and the compressed powder magnetic core, to thus achieve a high-power, high-speed, high-efficiency, and thin structured stator, and a motor having the same, in particular, a drive motor for a drum washing machine.

1. A single stator comprising:
a stator core;
a bobbin wrapped on an outer circumferential surface of the stator core; and
a coil wound on an outer circumferential surface of the bobbin,
wherein the stator core comprises:
a plurality of integration type core portions that are integrally formed by metal powders, and on which a coil is wound; and
a lamination type core portion that is formed in an annular shape by laminating a plurality of iron pieces, and that has at least one press-fit groove is formed in which each of the plurality of integration type core portions is press-fitted into and combined with the at least one press-fit groove, and
wherein the bobbin surrounds some of the outer circumferential surfaces of the plurality of integration type core portions and the lamination type core portion so as to integrate the plurality of integration type core portions and the lamination type core portion.

2. The single stator of claim 1, wherein the integration type core portion comprises: a yoke portion on which a coil is wound; and a flange portion that is integrally formed at one end of the yoke portion and that is disposed to face to a rotor, and
wherein coil winding grooves whose heights are lower than those of the upper and lower surfaces of the flange portion are formed on the upper and lower surfaces of the yoke portion, so as to reduce the height of the stator core.

3. The single stator of claim 1, wherein the integration type core portion is formed of amorphous metal powders, soft magnetic powders or alloy powders that are formed by mixing amorphous metal powders and spherical type soft magnetic powders.

4. The single stator of claim 2, wherein the lamination type core portion comprises:
a connecting portion on which a press-fit groove is formed in which the other end of the yoke portion is press-fitted into the press-fit groove;
a coupling protrusion that is spherically formed on one side of the connecting portion; and
a locking groove that is spherically formed so that a coupling protrusion of a lamination type core portion adjacent to the other side of the connecting portion is fitted into and coupled with the locking groove.

5. The single stator of claim 4, wherein a stack height of the lamination type core portion is set to be the same as a height of the yoke portion.

6. The single stator of claim 1, wherein a plurality of the press-fit grooves are formed at a predetermined interval on an outer surface of the lamination type core portion in which the respective integration type core portions are press-fitted into the press-fit grooves, a locking groove is formed at one end of the lamination type core portion, and a coupling protrusion is formed at the other end of the lamination type core portion so that the coupling protrusion is inserted into the locking groove formed in a neighboring lamination type core portion, and wherein the lamination type core portion is formed annularly in an arc form of a predetermined angle when the lamination type core portion is assembled with the neighboring lamination type core portion.

7. The single stator of claim 6, wherein the bobbin is formed by an insert-molding method on each of the outer circumferential surfaces of the annularly arranged lamination type core portion and the integration type core portions.

8. The single stator of claim 1, wherein the lamination type core portion is formed into a circular ring shape, in which a plurality of the press-fit grooves are formed at a predetermined interval on an outer surface of the lamination type core portion.

9. A single stator comprising:
a stator core;
a bobbin wrapped on an outer circumferential surface of the stator core; and
a coil wound on an outer circumferential surface of the bobbin,
wherein the stator core comprises:
a lamination type core portion that is formed by laminating a plurality of iron pieces, and that comprises: a ring portion that is formed in an annular shape; a yoke portion that is extended from one side of the ring portion and on which the coil is wound; and
a plurality of integration type core portions into which the yoke portion is press-fitted and that is integrally formed by compression-molding metal powders.

10. The single stator of claim 9, wherein the ring portion is formed in any one type of a type forming an annular shape in the case of being split and mutually assembled, a type forming an annular shape in the case of being formed of an arc shape and mutually assembled, and a third type forming a ring shape.

11. The single stator of claim 9, wherein the bobbin is formed to surround some of the outer circumferential surfaces of the integration type core portions and the lamination type core portion, so as to integrate the integration type core portions and the lamination type core portion.

12. The single stator of claim 9, wherein the ring portion and the yoke portion of the lamination type core portion are formed in an identical height.

13. A motor comprising:
a single stator comprising: a stator core; a bobbin wrapped on an outer circumferential surface of the stator core; and a coil wound on an outer circumferential surface of the bobbin; and
a single rotor that is disposed at a predetermined gap on an outer or inner circumferential surface of the single stator,
wherein the stator core comprises:
a plurality of integration type core portions that are integrally formed by metal powders, and on which a coil is wound; and
a lamination type core portion that is formed in an annular shape by laminating a plurality of iron pieces, and that has at least one press-fit groove is formed in which each of the plurality of integration type core portions is press-fitted into and combined with the at least one press-fit groove, and
wherein the bobbin surrounds some of the outer circumferential surfaces of the plurality of integration type core portions and the lamination type core portion so as to integrate the plurality of integration type core portions and the lamination type core portion.

14. A motor comprising:
a single stator comprising: a stator core; a bobbin wrapped on an outer circumferential surface of the stator core; and a coil wound on an outer circumferential surface of the bobbin; and
a single rotor that is disposed at a predetermined gap on an outer or inner circumferential surface of the single stator,
wherein the stator core comprises:
a lamination type core portion that is formed by laminating a plurality of iron pieces, and that comprises: a ring portion that is formed in an annular shape; a yoke portion that is extended from one side of the ring portion and on which the coil is wound; and
a plurality of integration type core portions into which the yoke portion is press-fitted and that is integrally formed by compression-molding metal powders.

15. The motor of claim 14, wherein the rotor comprises: a magnet that is arranged with a certain gap from a flange portion; a back yoke that is disposed on the rear surface of the magnet; and a rotor support to which the magnet and the back yoke are fixed, and that is coupled to a rotating shaft, and wherein a height of the magnet is formed in the same height as that of the flange portion.
